(19) United States
(12) Patent Application Publication
(10) Pub. No.: US 2007/0278161 A1
(43) Pub. Date: Dec. 6, 2007

(54) Waste Sludge Sanitizing Process Utilizing Biosolids Recycle

(75) Inventors: Samuel L. Shepherd, Houston, TX (US); Eric Prim, Odessa, TX (US)

Correspondence Address: CONLEY ROSE, P.C., 5601 GRANITE PARKWAY, SUITE 750, PLANO, TX, 75024, US

(73) Assignee: Holloman Corporation, Odessa, TX (US)

(21) Appl. No.: 11/421,179

(22) Filed: May 31, 2006

(51) Int. Cl. C02F 11/00

(52) U.S. Cl. 210/764

(57) ABSTRACT

A sludge treatment process comprising: mixing a sludge and a sanitizing agent to form a sludge mixture, the sanitizing agent comprising no more than about 20 percent of the sludge mixture, sanitizing the sludge mixture to substantially reduce or eliminate the pathogens therein, thereby forming biosolids, and recycling some of the biosolids into the sludge mixture. Included is a sludge treatment process comprising: sanitizing sludge to substantially reduce or eliminate the pathogens therein, thereby forming biosolids, wherein the sludge is substantially free of an acid. Also included is a sludge treatment process comprising: mixing a sludge, a sanitizing agent, and a stiffening agent to form a sludge mixture, heating the sludge mixture to substantially reduce or eliminate the pathogens therein, thereby forming biosolids, and recycling some of the biosolids into the sludge mixture, wherein the pH of the sludge mixture is at least about 9 prior to the heating step.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention generally relates to a process for the treatment of municipal, industrial, and agricultural sludges. More particularly, the present invention relates to a process that uses a reduced amount of raw materials to render biological waste sludges pathogen-free, vector-free, and sellable.

### BACKGROUND

Various techniques have been developed for the purpose of sanitizing, sterilizing, or decontaminating municipal, industrial, and agricultural sludges and biological wastes (collectively, “sludge”). The most common treatment process is application of heat to the sludge to substantially reduce or eliminate the pathogens therein. One common heating method is an exothermic chemical reaction, such as the one that occurs between lime and acid. When lime and acid are mixed with the sludge, the reaction between lime and acid elevates the temperature of the sludge. Once the sludge has been heated to a sufficient temperature, it must be held at the temperature for a sufficient amount of time to render the sludge substantially pathogen-free, at which point it is referred to as biosolids. The biosolids may then be disposed of or further treated to be sold as fertilizer.

Existing sludge treatment processes are not optimal because they require a large amount of raw materials to treat the sludge. For example, when the sludge treatment process relies on an exothermic chemical reaction to sanitize the sludge, the sludge treatment process requires a large amount of lime and acid to react together to heat the sludge to the required temperature. The large amounts of lime and acid produce a wet, low viscosity end product that has “soupy” properties, relatively low percent solids, and is unacceptable to the end user. Generally, the bulk of the raw materials are used to heat the sludge to the required temperature, rather than maintaining the heated sludge at the required temperature. In addition, if the pH of the sludge is inadequate, even more raw materials may need to be added to the sludge to adjust the pH to the required level. Consequently, what is needed is a sludge treatment process that does not suffer from the disadvantages present in the existing sludge treatment processes.

### SUMMARY OF THE INVENTION

In one aspect, the invention includes a sludge treatment process comprising mixing a sludge and a sanitizing agent to form a sludge mixture, the sanitizing agent comprising no more than about 20 percent of the sludge mixture, sanitizing the sludge mixture to substantially reduce or eliminate the pathogens therein, thereby forming biosolids, and recycling some of the biosolids into the sludge mixture. In one embodiment, the process further comprises adjusting the amount of recycled biosolids to achieve a pH of at least about 9 in the sludge mixture prior to the sanitizing step. In another embodiment, the process further comprises adjusting the amount of recycled biosolids from about 0 percent to about 400 percent of the sludge amount to achieve a temperature of at least about 90° F. in the sludge mixture prior to the sanitizing step. In yet another embodiment, the sludge mixture is sanitized by an exothermic reaction involving the sanitizing agent, thereby producing ammonia. The process may further comprise adjusting the amount of recycled biosolids to control the rate of the exothermic reaction. Alternatively, the sanitizing agent may react with water that originates from the group consisting of the sludge, the recycled biosolids, and combinations thereof. The sanitizing agent may be an oxide, a hydroxide, or a carbonate of a Group IA or IIA element. In an embodiment, the sludge mixture is substantially free of acid.

In another aspect, the invention includes a sludge treatment process comprising sanitizing a sludge to substantially reduce or eliminate the pathogens therein, thereby forming biosolids, wherein the sludge is sanitized essentially without the addition of an acid. Variously, the process may further comprise mixing a stiffening agent with the sludge, and/or selecting the stiffening agent based upon the chemical content of the sludge. In an embodiment, the stiffening agent is a pozzolanic material. In another embodiment, the process further comprises dewatering the sludge prior to the sanitizing step, wherein the dewatered sludge comprises from about 0.5 percent to about 35 percent solids. In embodiments, the process further includes raising the pH of the sludge to at least about 9 prior to the sanitizing step, and/or raising the temperature of the sludge to at least about 90° F. prior to the sanitizing step. In yet another embodiment, the sludge is sanitized by heat. In embodiments, the biosolids comprise at least about 20 percent solids, and/or the pathogen content of the biosolids complies with at least the Class B specification of 40 CFR part 503.

In a third aspect, the invention includes a sludge treatment process comprising mixing a sludge, a sanitizing agent, and a stiffening agent to form a sludge mixture, heating the sludge mixture to substantially reduce or eliminate the pathogens therein, thereby forming biosolids, and recycling some of the biosolids into the sludge mixture, wherein the pH of the sludge mixture is at least about 9 prior to the heating step. In an embodiment, the process further comprises flashing any non-recycled biosolids, thereby producing a vapor, and recycling the vapor into the sludge mixture, returning the vapor to a wastewater facility, or marketing the condensed vapor as a soil amendment.

### BRIEF DESCRIPTION OF THE DRAWINGS

FIG. 1 is a flowchart of the sludge sanitizing process;

FIG. 2 is an example of an apparatus for implementing the sludge sanitizing process;

FIG. 3 is a chart showing the relationship between the recycle ratio and the sludge mixture pH; and

FIG. 4 is a chart showing the relationship between the recycle ratio and the sludge mixture temperature.

### DETAILED DESCRIPTION OF THE PREFERRED EMBODIMENTS

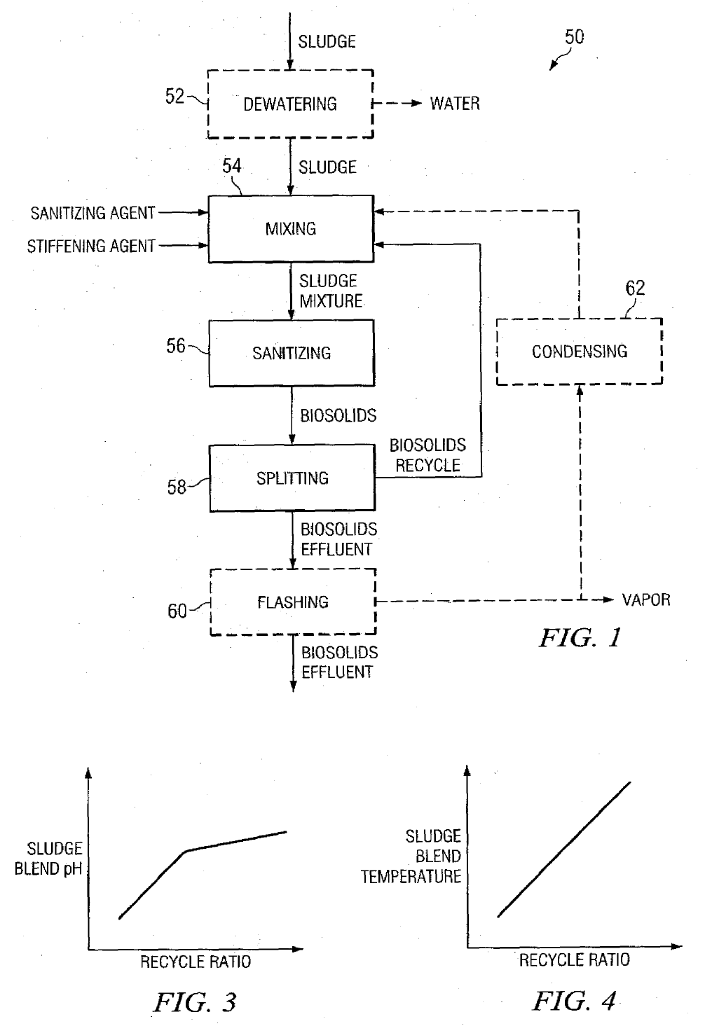

FIG. 1 illustrates one embodiment of a sludge sanitizing process 50. Generally, the sludge sanitizing process 50 comprises the steps of: mixing a sludge, a sanitizing agent, a stiffening agent, and a biosolids recycle to form a sludge mixture at 54, sanitizing the sludge mixture to transform it into biosolids at 56, and splitting the biosolids into the biosolids recycle and a biosolids effluent at 58. As shown in phantom in FIG. 1, the sludge sanitizing process 50 may optionally comprise the steps of: dewatering the sludge at 52, flashing the biosolids effluent at 60 to produce a vapor, and/or condensing the vapor at 62 and recycling the condensed vapor into the sludge mixture. Each of these steps is described in greater detail below.

The sludge sanitizing process 50 generally begins with the sludge. The sludge is a combination of biological solids and liquids, including municipal, industrial, and agricultural sludges and those from wastewater and sewage treatment plants. The sludge may also include inorganic materials including silicates, alumina, phosphates, and heavy metals such as lead, iron, and silver. The composition and physical properties of the sludge vary widely. For example, the sludge may contain from about 1 percent to about 99 percent solids, from about 5 percent to about 50 percent solids, or from about 10 percent to about 30 percent solids. In addition, the sludge may have a pH from about 4 to about 10, from about 5 to about 9, or from about 6 to about 8. The sludge may also have a temperature from about 40° F. to about 10° F., from about 50° F. to about 90° F., or from about 60° F. to about 80° F. The sludge also contains an appreciable number of pathogens, bacteria, and other microorganisms and is known to attract vectors including rats, flies, and other vermin. Consequently, the sludge may be treated by the sludge sanitization process disclosed herein to render it substantially pathogen-free and vector-free.

In an embodiment, the sludge may undergo an optional dewatering step per 52 of sludge sanitizing process 50. The dewatering step allows the amount of water in the sludge to be adjusted prior to mixing the sludge with the sanitizing agent, the stiffening agent, the biosolids recycle, and/or the vapor recycle. Several dewatering processes are known by persons of ordinary skill in the art, including heating or otherwise drying the sludge to evaporate some of the water therein. Alternatively, the sludge can be filtered to separate the desired amount of water from the remaining water and solids. Further in the alternative, the sludge can be exposed to a chemical drying agent that removes some of the water from the sludge. In embodiments, the dewatered sludge may contain at least about 0.01 percent solids, at least about 0.1 percent solids, or from about 0.5 percent to about 35 percent solids.

In an embodiment, the sanitizing agent is added to the sludge mixture. The sanitizing agent is a chemical compound that substantially reduces or eliminates the pathogens in the sludge and/or reduces the attraction of the sludge to vectors. The sanitizing agent may exothermically react with another chemical compound, such as water, thereby heating the sludge and destroying the pathogens. A sanitizing agent that exothermically reacts with water is advantageous because water is already present in the sludge, and thus water does not need to be added to the sludge. The amount of water in the sludge can be controlled by controlling the amount of water removed from the sludge in the dewatering step 52 and/or adjusting the amount of recycled biosolids. In embodiments, the sanitizing agent is an oxide, hydroxide, or carbonate of a Group IA or IIA element. Specific examples of sanitizing agents include lime, calcium hydroxide, calcium oxide, calcium carbonate, potassium hydroxide, potassium carbonate, and combinations thereof. The aforementioned sanitizing agents are also beneficial because they increase the pH of the sludge, which aids in sanitizing the sludge as explained in further detail below. In embodiments, the sludge mixture contains no more than about 20 percent, no more than about 10 percent, or no more than about 4 percent of the sanitizing agent, when measured on a wet cake basis prior to addition of the biosolids recycle.

In an embodiment, the stiffening agent is also added to the sludge mixture. The stiffening agent can be any chemical compound that increases the adhesion, viscosity, density, and/or solids content of the sludge. In preferred embodiments, the stiffening agent undergoes a hydration reaction in the sludge when exposed to water. The hydration reaction is exothermic and heats the sludge a few degrees. The high carbon content of the sludge prevents the stiffening agent from hardening into a cement-like material. Examples of suitable stiffening agents include cement, pozzolanic materials, such as aluminum, silicates, ferrous, and ferric materials, and combinations thereof. Cements are compounds that form a hardened mass when mixed with water. Similarly, pozzolanic materials are siliceous, ferrous, ferric, or aluminous compounds that form a hardened mass when mixed with water and calcium hydroxide. Although pozzolanic material may be found in volcanic emissions, industrial sources of pozzolans include: Class F fly ash from coal fired power plants, silica fume from silicon production, rice husk ash, and metakaolin from oil sands operation. Other cements, such as Portland cement, Class C fly ash and blast furnace slag may be used as the stiffening agent, but are not pozzolanic materials. In embodiments, the sludge mixture contains no more than about 30 percent, from about 0.1 percent to about 10 percent, or from about 1 percent to about 3 percent of the stiffening agent, when measured on a wet cake basis prior to addition of the biosolids recycle.

In an embodiment, the sludge, the sanitizing agent, the stiffening agent, and the biosolids recycle are mixed together to form the sludge mixture per step 54 of sludge sanitizing process 50. The sludge, the sanitizing agent, and the stiffening agent are typically stored in individual tanks or other suitable storage facilities and piped, pumped, metered, or otherwise transported to a mixer. The sludge, the sanitizing agent, the stiffening agent, and the biosolids recycle may be mixed together such that the sludge mixture becomes partially or completely homogenized. The mixer used to mix the sludge, the sanitizing agent, the stiffening agent, and the biosolids recycle may be a static mixer comprising of a plurality of baffles or a dynamic mixer comprising at least one moving agitator. In a preferred embodiment, the mixer is a screw conveyor, such as the one described in U.S. Pat. No. 6,056,880 to Boss et al. entitled “Process for Treating a Waste Sludge of Biological Solids,” incorporated herein by reference as if reproduced in its entirety.

In an embodiment, the sludge mixture is sanitized per step 56 of sludge sanitizing process 50. During the sanitizing step, the amount of pathogens in the sludge is substantially reduced or eliminated and/or attraction of the sludge to vectors is substantially reduced or eliminated. The United States Environmental Protection Agency (EPA) specifies the requirements for treating the sludge to render it substantially pathogen-free and vector-free in 40 CFR part 503 (hereinafter, the regulations), which are incorporated herein by reference as if reproduced in their entirety. There are several methods for sanitizing the sludge mixture, including those provided by the regulations. One example of a suitable sanitizing method is heating the sludge for a sufficient time and temperature, and optionally at a specific pH as provided by the regulations. The heating may be the result of an external heating apparatus, such as the immersion or magnetic field heaters described in U.S. Pat. No. 6,056,880. The heating may also be the result of a gas-fired dryer positioned at the end of the reactor. However, the heating is preferably the result of an exothermic chemical reaction occurring within the sludge, which may produce ammonia. Several different exothermic chemical reactions are suitable for sanitizing the sludge, including one in which the sanitizing agent reacts with another chemical compound in the sludge. For example, if the sanitizing agent is the oxide, hydroxide, or carbonate of a Group IA or IIA element such as lime, then the lime reacts with the water in the sludge to heat and sanitize the sludge.

After the sludge has been sanitized by heat and/or other methods, the sludge is referred to as biosolids. The biosolids are substantially pathogen-free and vector-free and may be EPA Class A, Class B, or other classes as specified by the regulations. The biosolids may contain at least about 20 percent solids, from about 25 percent to about 95 percent solids, or from about 30 percent to about 50 percent solids. The biosolids may have a pH of at least about 10, from about 11 to about 13, or about 12. Finally, the biosolids may have a temperature of at least about 120° F., from about 130° F. to about 240° F., or from about 140° F. to about 160° F. The biosolids also contain a substantial amount of sanitizing agent that remains in the biosolids after the sanitizing process ends.

The sludge sanitizing process 50 continues with the splitting of the biosolids into the biosolids effluent and the biosolids recycle per step 58. While many methods exist for splitting the biosolids into the effluent and recycle streams, one suitable method involves the use of a pipe tee and a pair of valves. More specifically, the biosolids may be split into the recycle and effluent streams by forcing the biosolids into a pipe tee with two exits and positioning a valve at each of the exits. The valves may then be open and closed to regulate the amount of biosolids in the recycle stream as well as the amount of biosolids in the effluent stream. The biosolids recycle is recycled back into the sludge mixture to increase the temperature, pH, sanitizing agent content, stiffening agent content, and water content of the sludge mixture. The biosolids effluent may be disposed of, further processed, or used as desired.

In an embodiment, the biosolids effluent may undergo an optional flashing step per step 60 of sludge sanitizing process 50. Flashing is a process in which the biosolids are passed from a region of relatively high pressure to a region of relatively low pressure. The change in pressure causes the volatile compounds within the biosolids to sublime or evaporate out of the biosolids. Examples of the volatile compounds that sublime or evaporate when flashed include ammonia, SOₓ, and water. The vapor is generally removed from the flash chamber and discarded. If desired, the vapor may be condensed per step 60 of sludge sanitizing process 50 so that the condensed vapor can be recycled into the sludge mixture. The flashing, condensing, and vapor recycling steps are disclosed in U.S. Pat. No. 5,868,942 to Boss et al. entitled “Process for Treating a Waste Sludge of Biological Solids,” incorporated herein by reference as if reproduced in its entirety. The remaining portion of the flashed biosolids may be disposed of, further processed, or used as desired.

FIG. 2 is an example of an apparatus 100 for implementing the sludge sanitizing process 50. Generally, the sludge is stored in a sludge storage tank 102 and may be optionally dewatered in a dewaterer 104 before being fed into a mixer 110 via a hopper 109. Similarly, the sanitizing agent is stored in the sanitizing agent storage tank 106 and the stiffening agent is stored in the stiffening agent storage tank 108 before being fed into mixer 110 via hoppers 109. The biosolids recycle stream 114 is also fed into mixer 110. Preferably, no acid is added to the sludge mixture. Mixer 110 may mix the sludge, the sanitizing agent, the stiffening agent, the biosolids recycle, and/or the vapor recycle into a partially homogenized or a completely homogenized sludge mixture. Mixer 110 may optionally compress and/or pressurize the sludge mixture to a pressure above atmospheric pressure. If desired, mixer 110 may also shear at least some of the water out of the sludge mixture so that the water may react more easily with the sanitizing agent and/or the stiffening agent. The sludge mixture is then passed to a reactor 112.

Reactor 112 is a device operable to sanitize the sludge mixture. For example, reactor 112 may be a plug flow reactor or may be a stirred tank reactor. While in reactor 112, the sludge mixture is sanitized to substantially reduce or eliminate the pathogens and transform the sludge into substantially pathogen-free, vector-free biosolids. Preferably, the sludge mixture is sanitized by heat, specifically an exothermic chemical reaction between the sanitizing agent and the water in the sludge and/or biosolids recycle. Reactor 112 may contain external temperature control apparatuses, such as heaters and/or coolers, which are particularly beneficial during start-up of the apparatus 100. However, while at steady state, the reactor temperature is preferably controlled by the exothermic chemical reaction occurring within reactor 112. The exothermic reaction rate and thus the reactor temperature may be controlled by regulating the amount of biosolids recycle 114 that are mixed with the sludge mixture. Controlling the reactor temperature is important because reactors are generally sized for a specific residence time, which means that the reactor temperature is the dominant factor that determines whether the biosolids meet the specifications provided by the regulations.

A controller 124 controls the biosolids recycle 114 and the biosolids effluent 130, as well as the pH, temperature, and pressure within the reactor. More specifically, controller 124 controls two actuators 122 that each open and close a valve 120. By varying the positions of the two valves 120, controller 124 can control the recycle ratio, namely the ratio of biosolids recycled 114 to biosolids effluent 130. High recycle ratios will increase the temperature, pressure, and pH within reactor 112, while low recycle ratios will decrease the temperature, pressure, and pH within reactor 112. In addition, controller 124 may simultaneously open or close the valves 120 to control the pressure within the reactor 112 independent of the pH and temperature. The controller 124 may obtain the pH, temperature, and pressure data from one or more pH meters 132, thermocouples 134, and/or pressure gauges 136. Controller 124 may use the pH, temperature, and pressure data to adjust the recycle ratio and valve position to achieve the desired pH, temperature, and pressure. Controller 124 may also control the temperature and/or pH of the reactor 112 by controlling the amount of sanitizing agent added to the sludge mixture. In embodiments, the controller 124 controls the biosolids recycle rate into the sludge mixture such that the biosolids recycle rate is between about 0 percent and about 400 percent of the sludge feed rate.

If desired, the biosolids effluent 130 may be flashed in a flash tank 116 to remove some of the volatile compounds within the biosolids. In such a case, the biosolids effluent 130 passes through an orifice 118 into flash tank 116 that has a lower pressure than the biosolids effluent 130. In flash tank 116, the volatile compounds sublime or evaporate from the biosolids and may be collected in vapor form in a vapor collection line 126. The vapor may then be discarded, returned to a wastewater facility, or condensed in a condenser 128 and recycled into mixer 110 or marketed as a soil amendment or additive. Persons of ordinary skill in the art will appreciate that the term condenser as it is used herein is inclusive of compressors, pumps, and other apparatuses that modify the phase, pressure, and/or temperature of a fluid. The reintroduction of such vapor can add nutrient value to the resulting biosolids. The biosolids that collect at the bottom of flash tank 116 may then be discarded further processed, or used as desired.

The recycled biosolids are beneficial because they increase the pH of the sludge mixture prior to the sanitizing step. Because the biosolids have a pH that is higher than the sludge mixture, recycling some of the biosolids into the sludge mixture will increase the pH of the sludge mixture before the sludge mixture enters the reactor. A higher pH is beneficial because it allows ammonia to be generated in the sludge mixture, which aids in the sanitizing of the sludge. As shown in FIG. 3, the sludge mixture pH is proportional to the recycle ratio until a transformation point is reached, at which point the pH is relatively independent of the recycle ratio. For example, when using lime as the sanitizing agent, the transformation point occurs at a recycle ratio of about 1 and a pH of about 11. Decreasing the recycle ratio below about 1 substantially decreases the pH and percent solids content of the sludge mixture, while increasing the recycle ratio above about 1 does not substantially increase the pH, but increases the percent solids of the sludge mixture. In embodiments, the recycle ratio is adjusted to achieve a sludge mixture pH of at least about 9, at least about 10, or at least about 11 prior to the sanitizing step.

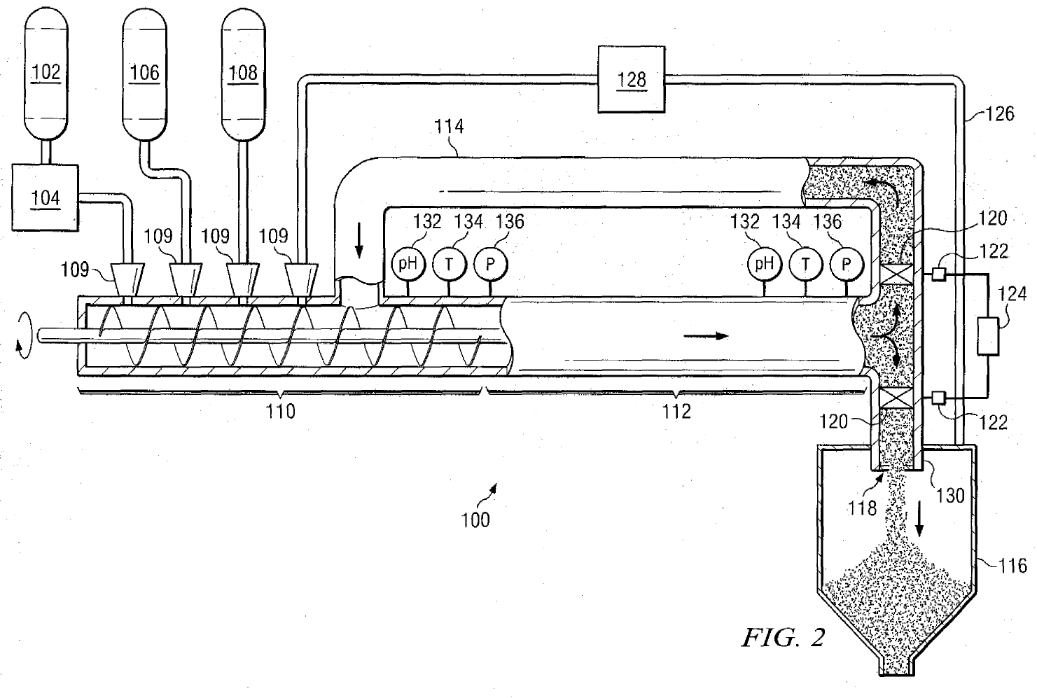

The recycled biosolids are also beneficial because they increase the temperature of the sludge mixture prior to the sanitizing step. Because the biosolids have a temperature that is higher than the sludge mixture, recycling some of the biosolids into the sludge mixture will increase the temperature of the sludge mixture before the sludge mixture enters the reactor. A high sludge mixture temperature is beneficial because it reduces the amount of sanitizing agent that has to be added to the sludge mixture, eliminates the need to add acid to the sludge mixture, increases the reaction rates, and/or decreases the required residence time. As shown in FIG. 4, the sludge mixture temperature is proportional to the recycle ratio. Returning to the example that uses lime as the sanitizing agent, a recycle ratio of about 1 will heat the sludge mixture to about 110° F. when the sludge has an initial temperature of about 70° F. Decreasing the recycle ratio below about 1 substantially decreases the temperature of the sludge mixtures while increasing the recycle ratio above about 1 substantially increases the temperature of the sludge mixture. In embodiments, the recycle ratio is adjusted to achieve a sludge mixture temperature of at least about 90° F., at least about 110° F., or at least about 110° F. prior to the sanitizing step.

The recycled biosolids are especially advantageous because they reduce the amount of raw materials consumed by the sludge sanitizing process. Specifically, the recycled biosolids reduce the amount of sanitizing agent that is required to achieve the desired temperature. For example, if the desired reactor temperature is 150° F., only 4 percent lime needs to be added to the sludge mixture when the sludge mixture contains recycled biosolids, as opposed to a pH of 12 that would be required if the sludge mixture did not contain recycled biosolids. The recycled biosolids also eliminate the need to add acid to the sludge mixture. Specifically, the recycled biosolids increase the temperature of the sludge mixture to a sufficient temperature such that the exothermic sanitizing agent reaction is sufficient to adequately heat the sludge mixture. Thus, it is not necessary to use the acid-lime reaction to heat the sludge. Eliminating the acid in the sludge mixture is also beneficial because acid decreases the pH of the sludge, and thus decreases ammonia production during the sanitizing process.

In some embodiments, it is preferable to analyze the chemical composition of the sludge and adjust the amount of sanitizing agent and/or stiffening agent as a result of such analysis. For example, if the sludge contains silicate, alumina, and/or ferrite compounds, then reduced amounts of these materials may be added to the sludge mixture, e.g. as stiffening agents. Similarly, if the sludge contains calcium hydroxide or other types of sanitizing agents, then the amount of required sanitizing agent can be reduced. Consequently, in many instances it is advantageous to analyze the chemical composition of the sludge prior to adding the sanitizing agent and/or the stiffening agent to the sludge.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Specifically, while the process is described in terms of a continuous process, it is contemplated that the process can be implemented as a batch process. In addition, where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference in the herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A sludge treatment process comprising:
mixing a sludge and a sanitizing agent to form a sludge mixture, the sanitizing agent comprising no more than about 20 percent of the sludge mixture;
sanitizing the sludge mixture to substantially reduce or eliminate the pathogens therein, thereby forming biosolids; and
recycling some of the biosolids into the sludge mixture.

2. The process of claim 1 further comprising: adjusting the amount of recycled biosolids to achieve a pH of at least about 9 in the sludge mixture prior to the sanitizing step.

3. The process of claim 1 further comprising: adjusting the amount of recycled biosolids from about 0 percent to about 400 percent of the sludge amount to achieve a temperature of at least about 90° F. in the sludge mixture prior to the sanitizing step.

4. The process of claim 1 wherein the sludge mixture is sanitized by an exothermic reaction involving the sanitizing agent, thereby producing ammonia.

5. The process of claim 5 further comprising: adjusting the amount of recycled biosolids to control the rate of the exothermic reaction.

6. The process of claim 1 wherein the sanitizing agent reacts with water that originates from the group consisting of: the sludge, the recycled biosolids, and combinations thereof.

7. The process of claim 1 wherein the sanitizing agent is an oxide, a hydroxide, or a carbonate of a Group IA or IIA element.

8. The process of claim 1 wherein the sludge mixture is substantially free of acid.

9. A sludge treatment process comprising:
sanitizing a sludge to substantially reduce or eliminate the pathogens therein, thereby forming biosolids;
wherein the sludge is sanitized essentially without the addition of an acid.

10. The process of claim 9 further comprising: mixing a stiffening agent with the sludge.

11. The process of claim 10 further comprising: selecting the stiffening agent based upon the chemical content of the sludge.

12. The process of claim 10 wherein the stiffening agent is a pozzolanic material.

13. The process of claim 9 further comprising: dewatering the sludge prior to the sanitizing step; wherein the dewatered sludge comprises from about 0.5 percent to about 35 percent solids.

14. The process of claim 13, further including raising the pH of the sludge to at least about 9 prior to the sanitizing step.

15. The process of claim 13, further including raising the temperature of the sludge to at least about 90° F. prior to the sanitizing step.

16. The process of claim 1 wherein the sludge is sanitized by heat.

17. The process of claim 1 wherein the biosolids comprise at least about 20 percent solids.

18. The process of claim 1 wherein the pathogen content of the biosolids complies with at least the Class B specification of 40 CFR part 503.

19. A sludge treatment process comprising:
mixing a sludge, a sanitizing agent, and a stiffening agent to form a sludge mixture;
heating the sludge mixture to substantially reduce or eliminate the pathogens therein, thereby forming biosolids; and
recycling some of the biosolids into the sludge mixture;
wherein the pH of the sludge mixture is at least about 9 prior to the heating step.

20. The process of claim 19 further comprising:
flashing any non-recycled biosolids, thereby producing a vapor; and
recycling the vapor into the sludge mixture, returning the vapor to a wastewater facility, or marketing the condensed vapor as a soil amendment.
